(19) United States
(12) Patent Application Publication
(10) Pub. No.: US 2011/0278513 A1
(43) Pub. Date: Nov. 17, 2011

(54) ROTARY TOOL ACCESSORY FOR GRABBING

(76) Inventor: Adam A. Esposito, Lombard, IL (US)

(21) Appl. No.: 13/096,123

(22) Filed: Apr. 28, 2011

(51) Int. Cl. B25C 11/00

(52) U.S. Cl. 254/18

(57) ABSTRACT

A rotary tool attaches to a reversible hand drill for assisted grabbing and releasing of an automotive plastic rivet using a pair of claws. A spindle attaches to a quick release chuck of the drill. The rotary tool converts rotary motion to linear motion causing the claws to open and close when the spindle is turned by a drill.

### BACKGROUND OF THE INVENTIONS

1. Technical Field

The present inventions relate to hand tools and, more particularly, relate to rotary accessories for mating with a drill chuck.

2. Description of the Related Art

Automotive plastic rivets are pins or clips that have been used for attaching auto body components. In auto body repair these plastic rivets usually need to be removed throughout an interior and exterior of vehicles.

One prior approach for removal of automotive plastic rivets has been specialized hand pliers, also known as clip tools, for gripping the plastic clips. Examples were the KD Tools Push Pin Pliers. These clip tools were difficult to grasp a clip and keep it from slipping off and breaking. It has been discovered the clip tools did not grab hard enough.

Another prior approach for removal of automotive plastic rivets has been screw driver like tools for prying and removing the plastic clips. An example was the Lisle 35260 plastic fastener removal tool. These prying tools were difficult to get into certain places and did not grasp the clip well and would break a clip if not seated correctly.

### SUMMARY OF THE INVENTIONS

A rotary tool attaches to a reversible hand drill for assisted grabbing and releasing of an automotive plastic rivet using a pair of claws. A spindle attaches to a quick release chuck of the drill. The rotary tool converts rotary motion to linear motion causing the claws to open and close when the spindle is turned by a drill.

It has been discovered the clip tools did not grab hard enough. Besides a firmer grasp to avoid breaking the pin, another advantage to the invention over the prior art is the enhanced control you have with the claws to get it in the tight spaces needed to remove the clips. Also, the torque from the drill creates a much stronger grip on the clip than you can make with any hand tools. The added strength keeps the claws from slipping off the clip and breaking it.

### BRIEF DESCRIPTION OF THE DRAWINGS

The present invention is illustrated by way of example and is not limited by the accompanying figures, in which like references indicate similar elements. Elements in the figures are illustrated for simplicity and clarity and have not necessarily been drawn to scale.

The details of the preferred embodiments will be more readily understood from the following detailed description when read in conjunction with the accompanying drawings wherein:

FIG. 1 illustrates a perspective view of a rotary tool according to one embodiment of the present inventions;

FIG. 2 illustrates a perspective view of a rotary tool attached to a chuck of a hand drill for assisted grabbing of a pin according to one embodiment of the present inventions;

FIG. 3 illustrates a perspective view of a rotary tool with a protective shroud according to one alternative embodiment of the present inventions; and

FIG. 4 illustrates an exploded perspective view of a rotary tool according to one embodiment of the present inventions; and

FIG. 5 illustrates a side view of a rotary tool for assisted grabbing of a pin according to one embodiment of the present inventions.

### DETAILED DESCRIPTION OF THE PREFERRED EMBODIMENTS

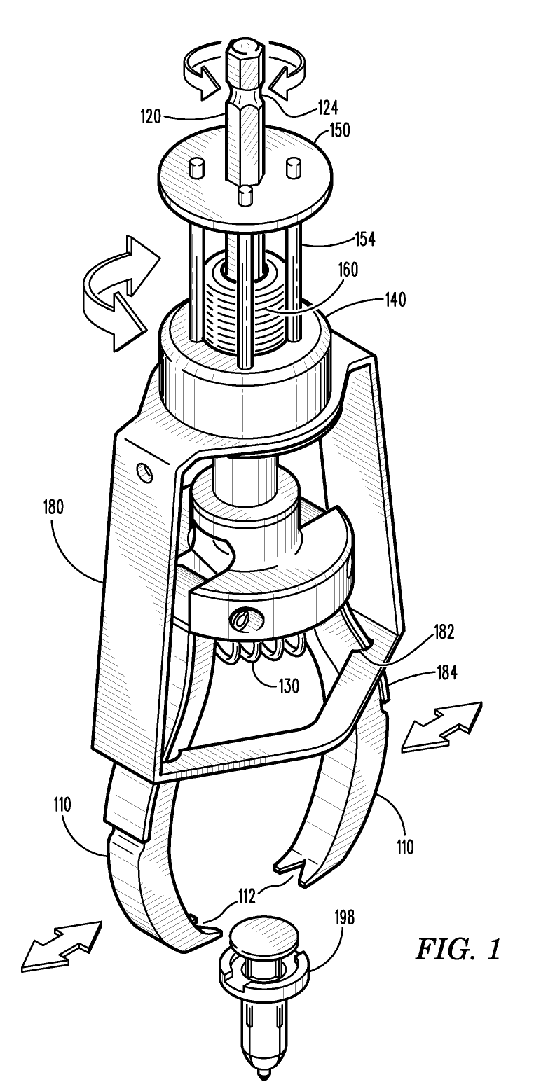

FIG. 1 illustrates a perspective view of a rotary tool according to one embodiment of the present inventions. The rotary tool is adapted for attachment to a chuck of a reversible hand drill for assisted grabbing and releasing of a pin 198 using a pair of claws 110. A spindle 120 is adapted to attach to a quick release chuck of a powered hand drill. The rotary tool has a mechanism causing the claws 112 to open and close when the spindle is turned by a drill attached thereto. This mechanism converts rotary motion to linear motion, thereby allowing the drill to assist movement of the claws 110.

Ends 112 of the claws 110 are each shaped with a v groove to better grasp an automotive plastic rivet 198. These automotive plastic rivets 198 are pins commonly used for attaching auto body components. In auto body repair these plastic rivets 198 usually need to be removed throughout an interior and exterior of vehicles. It is important to use a tool for the job so the plastic rivets 198 are not damaged and can be reused. A well seated tip on the claws helps remove the plastic rivets 198 without damage. Besides reliably removing the plastic rivets 198, the rotary tool of the present inventions is also useful for more rapidly removing these automotive plastic rivets 198.

An inner member 160 is disposed relative to the spindle 120 to move lengthwise when the spindle 120 is turned and coupled to open and close the claws 110 when inner member 160 moves lengthwise. The inner member 160 is coupled to the spindle 120 by threads on an outside surface thereof. The threads on the inner member 160 are absent at an end causing slip at an end of travel when the spindle 120 is turned after the claws 110 are closed.

A mechanism is provided for forcing the claws 110 together and apart when the spindle 120 is turned. This mechanism converts rotary motion to linear motion, thereby allowing the drill to assist movement of the claws.

A spring 130 between the claws 110 is compressed when the spindle 120 is turned by the drill to close the claws 110. This mechanism uses the spring 130 disposed between the claws 110 such that the spring 130 is compressed when the spindle 120 is turned by the drill to close the claws 110. When the drill turns the spindle 120 in an opposite direction, the spring 130 forces apart the claws 110. The spring does not typically force apart the claws 110 by themselves due to friction in the threads of the inner member 160. This helps make sure reversible drill movement can be used to control opening and closing of the claws 110. The drill speed can be adjusted to carefully close the claws 100 without damaging the pin 198 furring grasping. During releasing of the claws 100, the drill can operate faster because there less risk of damaging the plastic. This friction is not mandatory and in an alternative embodiment the claws could open on their own under force of a spring.

An outer housing 180 in one embodiment is adapted to hold the claws and force the claws apart using a mating groove 182 and a track 184 on each respective claw 110 and the outer housing 180 to cause the claws 110 to be forced together when the spindle 120 is turned by the drill to close the claws.

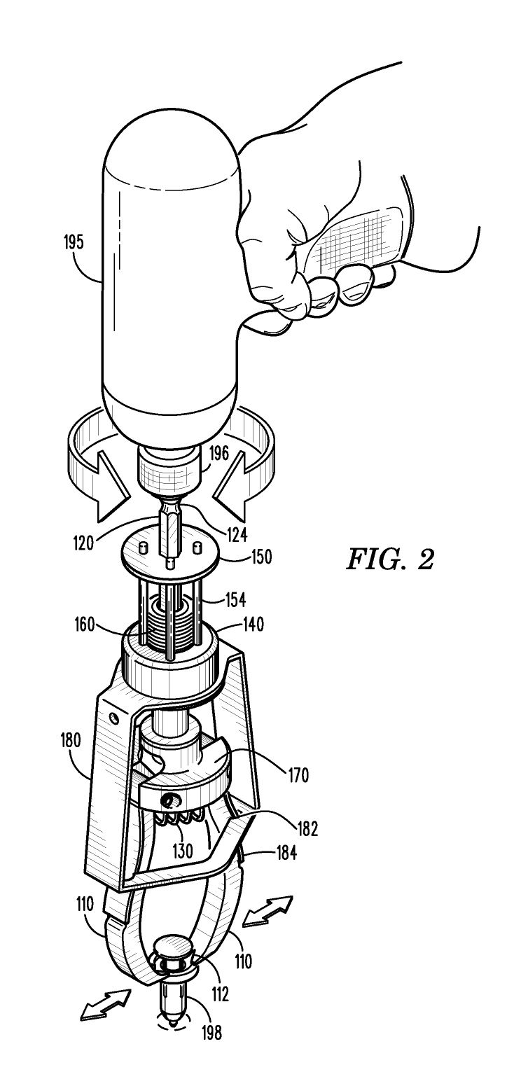

The spindle 120 preferably has a hex shaped cross-section and an annular dimple ring 124 adapted to mate with a locking collar of a quick release chuck on a conventional drill as is common on tools such as screw driver bits. Though the spindle 120 can adapt to any drill chuck, a preferred drill is a lightweight, cordless drill with a quick release chuck such as the Snap-on CTS561 Screwdriver 7.2V with a ¼″ Quick change chuck as illustrated in the example of FIG. 2.

The spindle has a drill chuck end and an end opposite the drill chuck end with a slip ring 140 fixedly coupled to the spindle 120 and having threads on an inner surface thereof and rotatably attached to the outer housing 180. An inner member 160 has threads on an outer surface thereof passing through the slip ring 140 and mating with the threads on the inner surface thereof.

A union 170 is coupled to the inner ends of the claws and fixedly coupled to the inner member 160 to move lengthwise when the spindle is turned. The inner member 160 is free of threads near the claws 110 such that its threads slip when the spindle is turned after the claws are closed. A disc 150 is fixedly coupled to the spindle 120 and fixedly coupled to the slip ring 140 via rods 154. Although a disc 150 and rods 154 couple to the spindle 120 to the slip ring 140, other mechanisms can be employed so long as rotary movement of the spindle 120 is coupled to the slip ring 140. For example, instead of the rods 154, sheet metal can be welded from the disc 150 to the spindle 120 to completely enclose the inner member 160.

FIG. 2 illustrates a perspective view of a rotary tool attached to a chuck 196 of a reversible hand drill 195 for assisted grabbing of a pin according to one embodiment of the present inventions. The drill chuck is preferably a quick release chuck on the reversible hand drill. The quick release chuck adapts to the hex shaped outer end of the spindle 120 and its annular dimple ring 124.

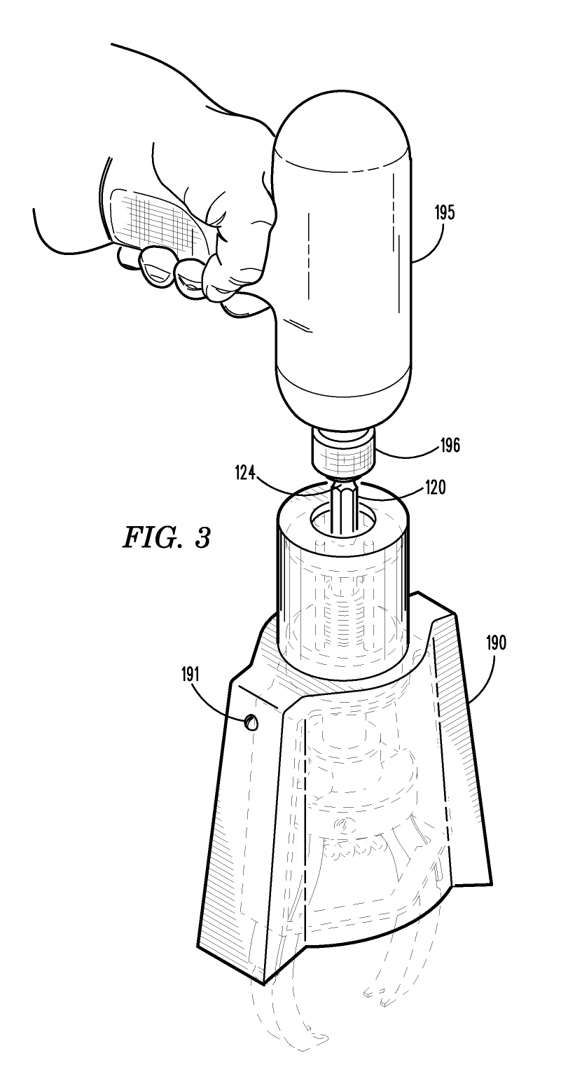

FIG. 3 illustrates a perspective view of a rotary tool with a protective shroud 190 according to one alternative embodiment of the present inventions. The protective shroud 190 is a safety surround housing for a hand hold and a safety shield to protect fingers from rotating parts. A screw and screw hole 191 can secure the protective shroud 190 to the outer housing. The protective shroud 190 can be formed in various different shapes. The protective shroud 190 extends up to also cover the mating component 150 and rods 154 and extends up to the base of the spindle 120. The protective shroud 190 can contour the outer housing 180 with six or more sides not all the same widths nor perfectly flat but somewhat contoured along the lines of the top end of the outer housing 180.

A stabilizing bracket, not illustrated, can be added in a further embodiment to fixedly couple the outer housing 180 or the protective shroud 190 to an outside of a drill 295 to hold the two together. This stabilizing bracket is not normally needed because both hands of a user are typically used to hold and operate—with one hand on the drill and the other hand on the safety shield 130. But a dedicated drill and apparatus combination might benefit from this stabilizing bracket secured with a clamp or screw to an outside of the drill for one handed use.

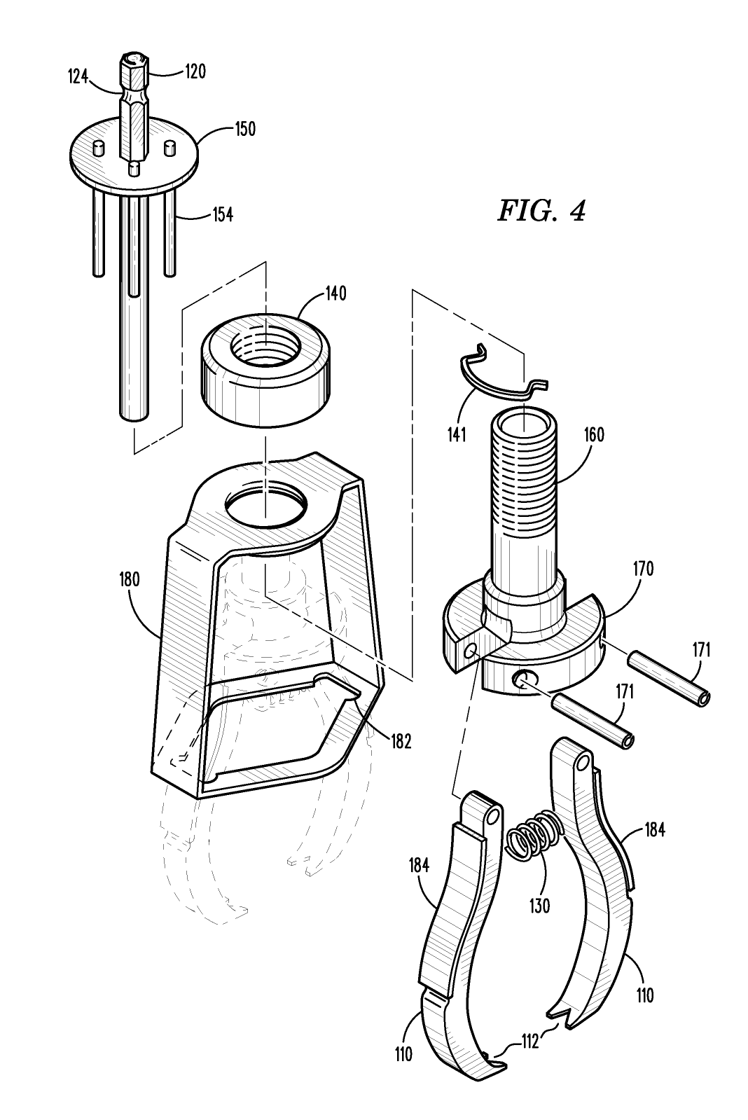

FIG. 4 illustrates an exploded perspective view of a rotary tool according to one embodiment of the present inventions. A somewhat U shaped wire clip 141 is illustrated installed against an under flange beneath the slip ring 140 and the outer housing 180. Pins 171 couple the union 170 to the claws 100. Like elements are like numbered as described herein.

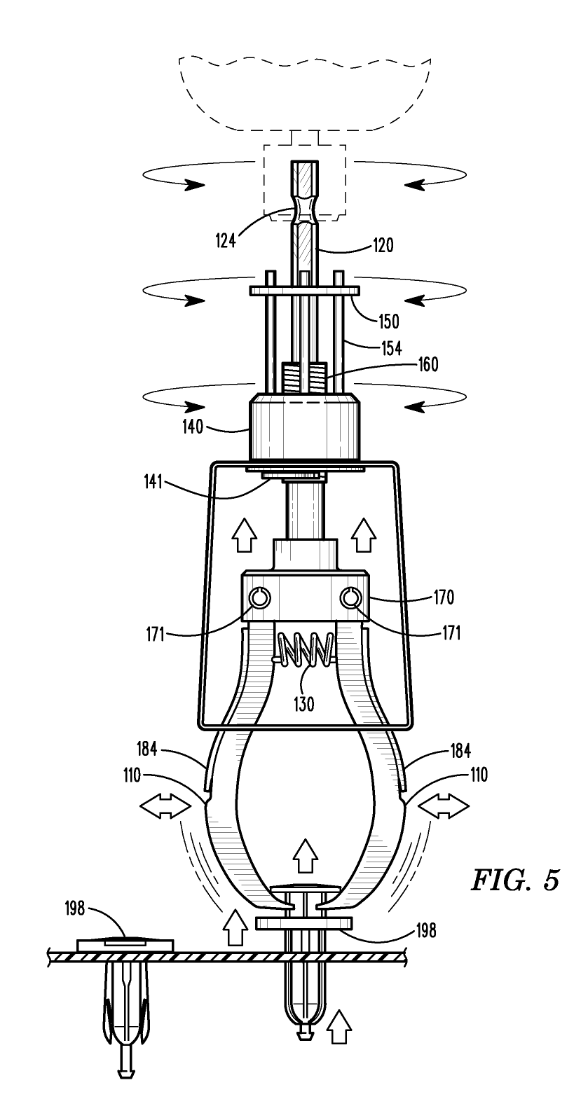

FIG. 5 illustrates a side view of a rotary tool for assisted grabbing of pins 198 according to one embodiment of the present inventions. Like elements are like numbered as described herein.

Although the rotary tool illustrated herein opens and closes the claws 110 in a horizontal direction, the threads between the ring 140 and the inner member 160 cause the claws 110 to also slightly move in a vertical direction. Because the rotary tool illustrated in the embodiment of FIG. 5 is used on a hand held tool, a user's arm is not stable in a vertical position. Thus any slight vertical movement of the claws 110 relative to hand movement of the tool makes the vertical claw movement insignificant in the application of the embodiment of FIG. 5. Typically the user's arm pulls the pin out after being grasped by the claws 110. The rotary tool in an alternate embodiment can have a different thread characteristic and length and thus be designed for significant vertical movement and horizontal movement.

Unless stated otherwise, terms such as “first” and “second” are used to arbitrarily distinguish between the elements such terms describe. Thus, these terms are not necessarily intended to indicate temporal or other prioritization of such elements.

Any trademarks listed herein are the property of their respective owners, and reference herein to such trademarks is generally intended to indicate the source of a particular product or service.

Although the inventions have been described and illustrated in the above description and drawings, it is understood that this description is by example only, and that numerous changes and modifications can be made by those skilled in the art without departing from the true spirit and scope of the inventions. Although the examples in the drawings depict only example constructions and embodiments, alternate embodiments are available given the teachings of the present patent disclosure.

What is claimed is:

1. An apparatus comprising:
claws; and
a spindle adapted to a drill chuck such that the claws are active to open and close when the spindle is turned by a drill attached thereto.

2. An apparatus according to claim 1, wherein the spindle and the claws are configured such that the claws are active to respectively open and close when the spindle is rotated in respective opposite directions by the drill chuck attached thereto.

3. An apparatus according to claim 1, further comprising an inner member operatively disposed relative to the spindle to move lengthwise when the spindle is turned and operatively coupled to open and close the claws the when inner member moves lengthwise.

4. An apparatus according to claim 3, wherein the inner member is coupled to the spindle by threads.

5. An apparatus according to claim 4, wherein the threads on the inner member slip at an end of travel when the spindle is turned after the claws are closed.

6. An apparatus according to claim 1, wherein the apparatus further comprises a mechanism for forcing the claws apart when the spindle is turned.

7. An apparatus according to claim 6, wherein the mechanism for forcing the claws apart comprises a spring operatively disposed between the claws such that the spring is compressed when the spindle is turned by the drill to close the claws.

8. An apparatus according to claim 7, wherein the mechanism for forcing the claws apart comprises a groove and track on each of the claws and an outer housing such that the claws are forced apart when the spindle is turned by the drill in a direction by the drill to open the claws.

9. An apparatus according to claim 8, wherein the apparatus further comprises a mechanism for forcing the claws together when the spindle is turned in an opposite direction.

10. An apparatus according to claim 8, wherein the mechanism for forcing the claws together comprises a groove and track on each of the claws and an outer housing such that the claws are forced together when the spindle is turned in an opposite direction by the drill to close the claws.

11. An apparatus according to claim 1, wherein each of the claws comprises a groove at an end thereof shaped to grip an automotive plastic rivet.

12. An apparatus according to claim 1, wherein the spindle comprises a hex shaped cross-section.

13. An apparatus according to claim 12, wherein the spindle further comprises an annular dimple ring adapted to fit a quick release drill chuck.

14. An apparatus according to claim 1,
wherein the apparatus further comprises an outer housing adapted to hold the claws;
wherein the spindle comprises a drill chuck end and an end opposite the drill chuck end comprising a slip ring fixedly coupled to the spindle and having threads on an inner surface thereof and rotatably attached to the outer housing; and
an inner member comprising threads on an outer surface thereof passing through the slip ring and mating with the threads on the inner surface thereof.

15. An apparatus according to claim 14, further comprising
a union coupled to the inner ends of the claws and fixedly coupled to the inner member to move lengthwise when the spindle is turned.

16. An apparatus according to claim 15, wherein the inner member comprises a region free of threads near the claws such that the threads slip when the spindle is turned after the claws are closed.

17. An apparatus according to claim 16, wherein the apparatus further comprises a spring between the claws that is compressed when the spindle is turned by the drill to close the claws.

18. An apparatus according to claim 1, wherein the apparatus further comprises a safety surround housing for a hand hold and a safety shield from rotating parts.
